(19) United States
(12) Patent Application Publication
(10) Pub. No.: US 2006/0132028 A1
(43) Pub. Date: Jun. 22, 2006

(54) Electroluminescent display construction using printing technology

(75) Inventor: Frank E. Anderson, Sadieville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/092,090

(22) Filed: Mar. 29, 2005

Related U.S. Application Data
(60) Provisional application No. 60/636,683, filed on Dec. 16, 2004.

(51) Int. Cl. H05B 33/06; H01J 1/62

(52) U.S. Cl. 313/506

(57) ABSTRACT

A method of fabricating an electroluminescent display comprising: (a) depositing a conductive pathway upon a substrate; (b) depositing a dielectric material over at least a first portion of the conductive pathway; and (c) depositing an electroluminescent material over the dielectric material and in contact with at least a second portion of the conductive pathway, where at least one of the deposition acts is carried out utilizing an inkjet printer. The invention also includes an electroluminescent display comprising a stacked structure including at least three aspects, with a first aspect comprising a conductive pathway, a second aspect comprising a dielectric material overlying at least a portion of the conductive pathway, and a third aspect comprising an electroluminescent material overlying at least a portion of the dielectric material and in electrical communication with at least a portion of the conductive pathway, wherein at least one of the aspects is deposited utilizing an inkjet printer, and wherein electric current is adapted to be provided to the first component to generate an electromagnetic field causing a photoemission from the electroluminescent material.

### CROSS REFERENCE TO RELATED APPLICATIONS

This application claims the benefit of U.S. Provisional Patent Application Ser. No. 60/636,683, filed Dec. 16, 2004, and entitled “ELECTROLUMINESCENT DISPLAY CONSTRUCTION USING PRINTING TECHNOLOGY,” the disclosure of which is incorporated herein by reference.

### RELATED ART

1. Field of the Invention

The present invention is directed to printed electronics and, more specifically, to printed electronics utilizing digital printing technology.

2. Art Related to the Invention

An electroluminescent (EL) device is a self-emission display where light is emitted from the organic compound film by electron-hole recombination when a current is applied to a fluorescent or phosphorescent organic compound film. EL devices are generally lightweight, while exhibiting a high visibility and a wide viewing angle. Also, an EL device can be configured to present a motion picture display and achieve a high color purity.

EL devices are generally classified in one of two classes: passive matrix (PM), and an active matrix (AM). In a PM EL device, a first set of electrodes and a second set of electrodes are arranged in a matrix configuration to produce a pixel area at each intersection. When scan lines are sequentially selected, a pixel area selected by a data line signal instantaneously emits light.

In an AM EL device, a plurality of thin film transistors (TFTs) and pixel electrodes electrically connected to the TFTs are arranged at the respective intersections of scan lines and data lines, so common electrodes entirely cover over the TFTs and pixel electrodes. Voltages applied to the respective pixels are completely independently sustained and the respective pixels are independently driven according to electrical signals applied to scan lines and data lines.

### SUMMARY

The present invention is directed to printed electronics and, more specifically, to printed electronics utilizing digital printing technology. The present invention includes a new electroluminescent (EL) device not requiring a matrix to provide a predetermined display. In addition, the present invention utilizes inkjet printing technology to deposit selected materials upon a substrate in a predetermined configuration to provide an EL device, whether or not the EL device includes an electrode matrix.

It is a first aspect of the present invention to provide a method of fabricating an electroluminescent display comprising: (a) depositing a conductive pathway upon a substrate; (b) depositing a dielectric material over at least a first portion of the conductive pathway; and (c) depositing an electroluminescent material over the dielectric material and in contact with at least a second portion of the conductive pathway, where at least one of the deposition acts is carried out utilizing an inkjet printer.

In a more detailed embodiment of the first aspect, the act of depositing the conductive pathway upon the substrate is carried out utilizing the inkjet printer, and the inkjet printer utilizes a conductive ink including a first carrier fluid. In yet another more detailed embodiment, at least one of the first carrier fluid, the second carrier fluid, and the third carrier fluid is water-based. In a further detailed embodiment, the act of depositing the dielectric material in contact with at least the first portion of the conductive pathway is carried out utilizing the inkjet printer, and the inkjet printer utilizes a dielectric ink including a second carrier fluid. In still a further detailed embodiment, the act of depositing the electroluminescent material in contact with the dielectric material and in contact with at least the second portion of the conductive pathway is carried out utilizing the inkjet printer, and the inkjet printer utilizes an electroluminescent ink including a third carrier fluid. In a more detailed embodiment, the act of depositing the dielectric material over at least the first portion of the conductive pathway occurs prior to the act of depositing the electroluminescent material over the dielectric material and in contact with at least the second portion of the conductive pathway. In another more detailed embodiment, the deposition acts occur sequentially such that the act of depositing the electroluminescent material over the dielectric material and in contact with at least the second portion of the conductive pathway immediately follows the act of depositing the dielectric material over at least the first portion of the conductive pathway that immediately follows the act of depositing the conductive pathway upon the substrate.

It is a second aspect of the present invention to provide a method of fabricating an electroluminescent display comprising: (a) depositing a dielectric material over at least a portion of a conductive material previously deposited; (b) depositing an electroluminescent material over at least a portion of the dielectric material, where the act of depositing the dielectric material and the act of depositing the electroluminescent material occur sequentially.

In a more detailed embodiment of the second aspect, the conductive material is deposited by vaporizing a portion of a conductive ink that includes the conductive material, the act of vaporizing the portion of the conductive ink is operative to deposit the conductive material in a predetermined conductive material pattern, and the predetermined conductive material pattern includes at least three conductive mesas, with at least one of the three conductive mesas being separable from an adjacent conductive mesa. In yet another more detailed embodiment, the dielectric material is deposited by vaporizing a portion of a dielectric ink that includes the dielectric material, the act of vaporizing the portion of the dielectric ink is operative to deposit the dielectric material in a predetermined dielectric material pattern, and the predetermined dielectric material pattern includes conductively separating at least one of the three conductive mesas from the adjacent conductive mesa. In a further detailed embodiment, the act of vaporizing the portion of the electroluminescent ink is operative to deposit the electroluminescent material in a predetermined electroluminescent material pattern, and the predetermined electroluminescent material pattern includes interposing electroluminescent material between at least two adjacent conductive mesas. In still a further detailed embodiment, a portion of the dielectric material deposited is removed to generate a first predetermined dielectric material pattern, and the first predetermined dielectric material pattern includes conductively separating at least one of the three conductive mesas from the adjacent conductive mesa. In a more detailed embodiment, the electroluminescent material is deposited by vaporizing a portion of an electroluminescent ink that includes the electroluminescent material, the act of vaporizing the portion of the electroluminescent ink is operative to deposit the electroluminescent material in a predetermined electroluminescent material pattern, and the predetermined electroluminescent material pattern includes interposing electroluminescent material between at least two adjacent conductive mesas.

In yet another more detailed embodiment of the second aspect, a portion of the conductive material deposited is removed to generate a first predetermined pattern, and the first predetermined pattern includes at least three conductive mesas, with at least one of the three conductive mesas being electrically separable from an adjacent conductive mesa. In still another more detailed embodiment, the dielectric material is deposited by vaporizing a portion of a dielectric ink that includes the dielectric material, the act of vaporizing the portion of the dielectric ink is operative to deposit the dielectric material in a predetermined dielectric material pattern, and the predetermined dielectric material pattern includes conductively separating at least one of the three conductive mesas from the adjacent conductive mesa. In a further detailed embodiment, the electroluminescent material is deposited by vaporizing a portion of an electroluminescent ink that includes the electroluminescent material, the act of vaporizing the portion of the electroluminescent ink is operative to deposit the electroluminescent material in a predetermined electroluminescent material pattern, and the predetermined electroluminescent material pattern includes interposing electroluminescent material between at least two adjacent conductive mesas. In still a further detailed embodiment, a portion of the dielectric material deposited is removed to generate a first predetermined dielectric material pattern, and the first predetermined dielectric material pattern includes conductively separating at least one of the three conductive mesas from the adjacent conductive mesa. In a more detailed embodiment, the electroluminescent material is deposited by vaporizing a portion of an electroluminescent ink that includes the electroluminescent material, the act of vaporizing the portion of the electroluminescent ink is operative to deposit the electroluminescent material in a predetermined electroluminescent material pattern, and the predetermined electroluminescent material pattern includes interposing electroluminescent material between at least two adjacent conductive mesas.

In a further detailed embodiment of the second aspect, a second conductive material is deposited over at least a portion of the electroluminescent material previously deposited. In yet another more detailed embodiment, a second dielectric material is deposited over at least a portion of the electroluminescent material previously deposited, and a second conductive material is deposited over at least a portion of the second dielectric material previously deposited.

It is a third aspect of the present invention to provide an electroluminescent display comprising a stacked structure including at least three aspects, with a first aspect comprising a conductive pathway, a second aspect comprising a dielectric material overlying at least a portion of the conductive pathway, and a third aspect comprising an electroluminescent material overlying at least a portion of the dielectric material and in electrical communication with at least a portion of the conductive pathway, where at least one of the aspects is deposited utilizing an inkjet printer, and where electric current is adapted to be provided to the first component to generate an electromagnetic field causing a photoemission from the electroluminescent material.

In a more detailed embodiment of the third aspect, a second dielectric material is deposited to overly at least a portion of the electroluminescent material, and a second conductive pathway is deposited to overly at least a portion of the second dielectric material. In yet another more detailed embodiment, the conductive pathway includes a plurality of conductive mesas, the dielectric material is deposited to separate at least a first conductive mesa and a third conductive mesa from a second conductive mesa, the electroluminescent material is deposited in communication with at least a portion of the dielectric material and at least a portion of the second conductive mesa of the second conductive pathway includes a plurality of conductive mesas, and the second dielectric material is operative to separate the second conductive pathway from the electroluminescent material. In a further detailed embodiment, the conductive pathway includes a plurality of conductive mesas, the dielectric material is deposited to separate at least a first conductive mesa and a third conductive mesa from a second conductive mesa, and the electroluminescent material is operative to separate the second conductive pathway from the electroluminescent material. In still a further detailed embodiment, the conductive pathway includes a plurality of conductive mesas, the dielectric material is deposited to separate at least a first conductive mesa and a third conductive mesa from a second conductive mesa, and the electroluminescent material is deposited in communication with at least a portion of the dielectric material and at least a portion of the second conductive mesa.

### BRIEF DESCRIPTION OF THE DRAWINGS

FIG. 1 is an overhead view of an exemplary inkjet printer having deposited materials comprising a first exemplary display of the present invention;

FIG. 2 is a cross-sectional view taken along lines 1-1 of FIG. 1;

FIG. 3 is a cross-sectional view taken along lines 1-1 of a first alternate exemplary display fabricated in accordance with the present invention; and

FIG. 4 is an elevated cut-away perspective view of a second exemplary embodiment of the present invention.

### DETAILED DESCRIPTION

The exemplary embodiments of the present invention are described and illustrated below to encompass methods, and devices resulting from such methods, for fabricating printed electronics such as, without limitation, an electroluminescent display. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention. It is also to be understood that variations of the exemplary embodiments contemplated by one of ordinary skill in the art shall concurrently fall within the scope and spirit of the invention.

The present invention utilizes printing technology to deposit materials and provide a stacked structure embodying an electroluminescent display. Reference will now be had to the drawings describing the fabrication process for the first exemplary embodiment of the present invention.

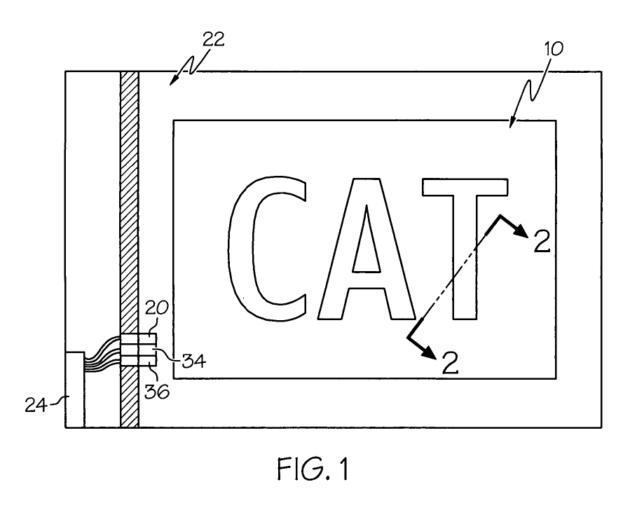

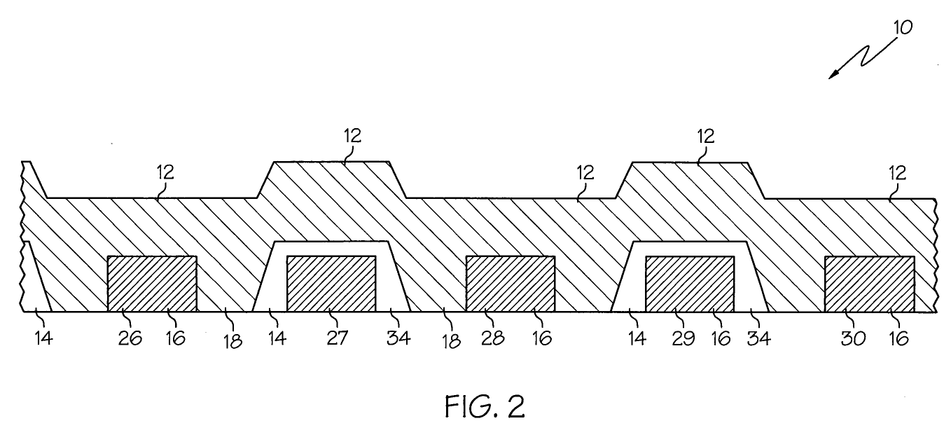

Referencing FIGS. 1 and 2, a first exemplary electroluminescent display 10 includes an electroluminescent material 12 in communication with a dielectric material 14 and one or more conductive pathways 16 formed on a substrate 18. For purposes of illustration only, the substrate 18 is comprised of premium photo glossy paper commercially available from Pictorico Corporation (www.pictorico.com), while each conductive pathway 16 is comprised of silver derived from a silver ink commercially available from Nippon (www.npacorp.com). It is to be understood that substrates other than paper may be used with the present invention such as, without limitation, polymer substrates, composite substrates, glass substrates, and semiconductive substrates.

Fabricating the first exemplary electroluminescent display 10 includes properly orienting the substrate 12 with respect to an inkjet nozzle array 20 of an inkjet printer 22. A printer controller 24 is operative to control the position of the nozzle array 20 and the activation of one or more of the nozzles in order to eject droplets of ink at predetermined locations upon the substrate 12. In a first exemplary printing sequence, the printer 22 is operative to eject droplets of conductive ink from the array 20 to form the conductive pathways 16 upon the substrate 18. Those of ordinary skill are familiar with the control commands necessary to deposit droplets of ink in predetermined locations upon a substrate utilizing inkjet technology, such as, without limitation using thermal inkjet technology and piezoelectric inkjet technology. For purposes of explanation only, the conductive pathways 16 include a series of spaced apart conductive paths 26, 27, 28, 29, 30, etc. oriented to graphically represent and spell out “CAT” upon the substrate 18. The particular shape and orientation of the conductive paths 26, 27, 28, 29, 30, etc., as well as the spacing between the conductive paths 26, 27, 28, 29, 30, etc., are within the purview of one of ordinary skill. For purposes of explanation only, the conductive paths 26, 27, 28, 29, 30, etc., of the first exemplary embodiment include widths of approximately 25 microns to 20 millimeters, and heights of approximately 1 to 50 microns, with the conductive paths being spaced apart by approximately 20 to 200 microns.

The same 22 or a different printer includes a second nozzle array 32 adapted to deposit dielectric material 14 upon the substrate 18. The printer controller 24 is operative to control the position of the nozzle array 32 and the activation of the nozzles in order to eject droplets of dielectric material 14 over at least some of the conductive paths 27, 29 to form dielectric mounds 34, while leaving other conductive paths 26, 28, 20 uncovered. The dielectric mounds 34 have an average depth of approximately 2 microns, and an exemplary range of 1 micron to 50 microns. For purposes of explanation, the dielectric material 14 is comprised of pigmented ink (carbon and polymer in a water-based solution) commercially available from Lexmark International, Inc. (www.lexmark.com).

A third nozzle array 36 of the same 22 or a different printer is adapted to deposit an electroluminescent ink, including an electroluminescent material 12, onto the substrate 18. The printer controller 24 is operative to position the array 36 with respect to the substrate 18 in order to deposit droplets of electroluminescent ink onto predetermined locations of the substrate 18 such as, without limitation, over the dielectric mounds 34 and the conductive paths 26, 28, 30. The electroluminescent material 12 is deposited to have an average depth of approximately 2 microns, and an exemplary depth range of approximately 0.5 microns to 10 microns. For purposes of explanation, the electroluminescent ink includes an electroluminescent material 12 comprised of phosphors commercially available from Nichia (www.nichia.com).

Leads (not shown) are connected to the respective conductive pathways 26, 27, 28, 29, 30 enabling communication with an alternating current source having a voltage between 10-300 volts, for example. The alternating current traveling through the conductive paths 26, 27, 28, 29, 30 is operative to generate an electromagnetic field that energizes the electroluminescent material 12 and results in photoemissions from the electroluminescent material 12 that are at least viewable from a line of sight facing the electroluminescent material 12. The intensity of the photoemissions can be controlled by circuitry (not shown) in electrical communication with the conductive paths 26, 27, 28, 29, 30 that varies the voltage supplied to the conductive paths. Those of ordinary skill are familiar with control circuitry operative to vary a voltage of an electrical current.

It is also within the scope if the invention to connect leads (not shown) to the respective conductive pathways 26, 27, 28, 29, 30 enabling communication with a direct current source having a voltage between 3-25 volts, for example. The direct current traveling through the conductive paths 26, 27, 28, 29, 30 is operative to generate an electric field that energizes the electroluminescent material 12 and generates photoemissions that are at least viewable from a line of sight facing the electroluminescent material 12. The intensity of the photoemissions can be controlled by circuitry (not shown) in electrical communication with the conductive paths 26, 27, 28, 29, 30 that varies the voltage supplied to the conductive paths. As discussed above, those of ordinary skill are familiar with control circuitry operative to vary a voltage of an electrical current.

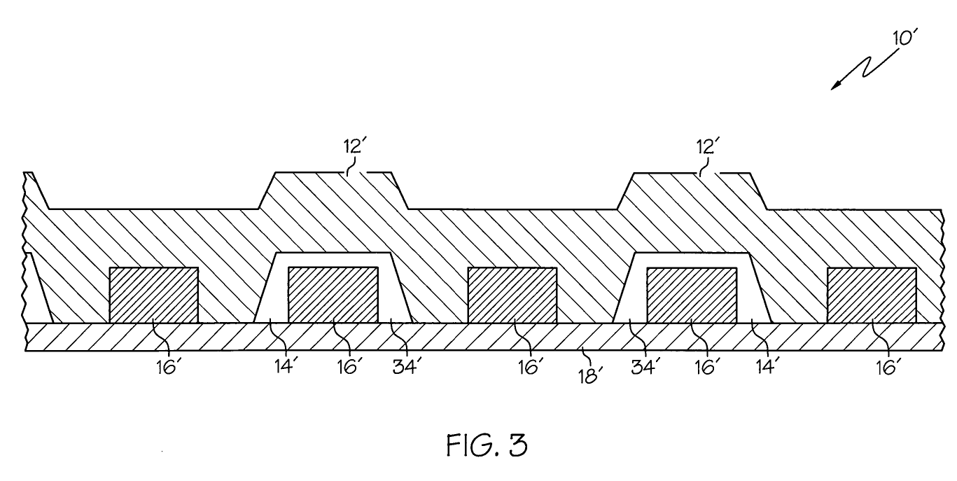

Referring to FIG. 3, a first alternate exemplary embodiment 10′ of the invention is fabricated using a translucent substrate 18′, such as glass, in lieu of the paper-based substrate 18 of the first exemplary embodiment 10. When utilizing a translucent substrate 18′, light generated by the electroluminescent material 12′ is concurrently visible from a line of sight facing the electroluminescent side of the display 10′, as well as visible from a line of sight facing the translucent substrate 18′. This alternate display 10′ may be utilized to provide an image viewable from at least two sides of the display 10′. An exemplary circumstance may be an advertising sign 10′ that is positioned on the inside of a window of a retail establishment, where the electroluminescent side faces the window and the substrate side faces the interior of the retail establishment. By fabricating the sign 10′ in accordance with the first alternate exemplary embodiment, a first image and a mirror image thereof are viewable from corresponding sides of the sign 10′.

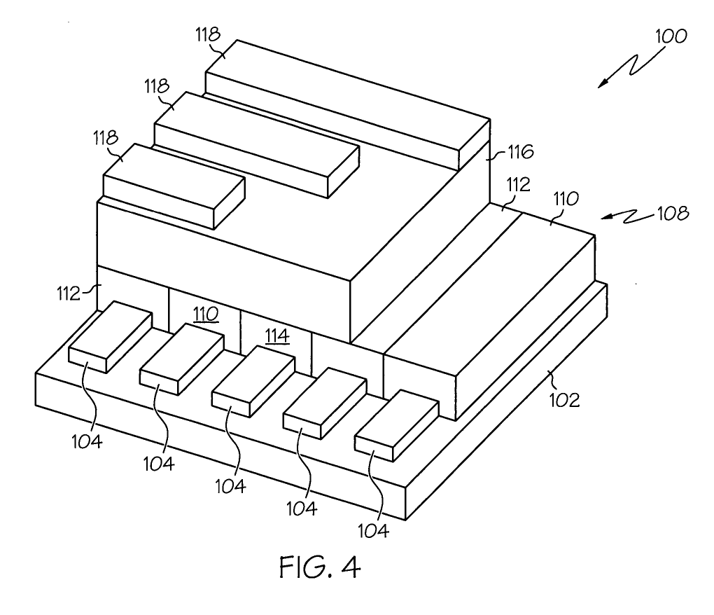

Referencing FIG. 4, a second exemplary electroluminescent display 100 is comprised of a stacked structure including a first set of conductive paths 104 mounted to a translucent substrate 102. Exemplary translucent substrates 102 include, without limitation, glass. In an exemplary orientation, the conductive paths 104 traverse across the substrate 102 in an east-to-west fashion to provide a series of parallel, spaced apart conductive paths 104. The conductive paths 104 are comprised of indium tin oxide deposited utilizing at least one of sputtering, chemical vapor deposition, and ink droplet deposition generally to a thickness approximately of 2 microns (generally between 1-50 microns), however, conductive materials other than indium tin oxide known to those of ordinary skill may be utilized.

An electroluminescent material 108 is deposited over the substrate 102 to cover the conductive paths 104. The electroluminescent material 108 may be deposited to a depth of approximately 2 microns (generally between 1-50 microns) utilizing conventional techniques known to those of ordinary skill, or novel techniques such as ink droplet deposition using an inkjet printer. As discussed previously, an exemplary electroluminescent material 108 may be deposited using an electroluminescent ink comprised of phosphors commercially available from Nichia (www.nichia.com).

Alternatively, the electroluminescent material 108 may be comprised of Red-Green-Blue (RGB) phosphor strips that are deposited longitudinally along the longitudinal paths 104, where the RGB phosphor strips 110, 112, 114 are sequentially deposited in a repetitious pattern to a depth of approximately 2 microns. For example, a Red phosphor strip 110 is next to a Green phosphor strip 112, which is next to a Blue phosphor strip 114, which is next to another Red phosphor strip 110. These RGB phosphor strips may be deposited at the same time or deposited in sequential manner using, such as, without limitation, electrophoretic deposition.

Depending upon the end application and the methods employed to fabricate the electroluminescent display 100, it may be advantageous to planarize the electroluminescent material 108 subsequent to deposition.

A dielectric material 116 is deposited over the electroluminescent material 108 to a depth of approximately 2 microns (generally between 1-50 microns). The dielectric material 116 may be deposited utilizing at least one of the techniques known to those of ordinary skill, or a novel technique such as ink droplet deposition. As discussed previously, an exemplary dielectric for use with the present invention includes, without limitation, a pigmented ink (carbon and polymer in a water-based solution) commercially available from Lexmark International, Inc.(www.lexmark.com). Depending upon the end application and the methods employed to fabricate the electroluminescent display 100, it may be advantageous to planarize the dielectric layer 116 subsequent to deposition.

A second set of conductive paths 118 is deposited over the dielectric material 116 in a generally linear pattern. In an exemplary orientation, the conductive paths 118 traverse across the substrate 102 in a north-to-south fashion to provide a series of parallel, spaced apart conductive paths 118 that transverse the underlying conductive paths 104. The conductive paths 118 need not be comprised of translucent materials as are the first set of conductive paths 104, and may be deposited to a thickness of approximately 2 microns (generally between 1-50 microns) utilizing conventional techniques such as sputtering, chemical vapor deposition, or novel techniques such as ink droplet deposition using a silver ink commercially available from Nippon. Other conductive materials may be deposited in lieu of or in addition to the silver and include, without limitation, conductive metals such as copper, aluminum, and gold.

An optional backing material (not shown) may be applied to the display 100 to maintain the respective position of the layers. The backing material may be comprised of a layer of glass and include a dielectric layer planarized to match the topography of the layer of glass.

Leads (not shown) are connected to the respective conductive pathways 104, 118 enabling communication with an alternating current source having an exemplary voltage between 10-300 volts. An electromagnetic field is created by the alternating flow of current that energizes the electroluminescent material 108 and results in photoemissions from the electroluminescent material 108. Control circuitry (not shown) in communication with the conductive pathways 104, 118 may be operative to change the intensity of the photoemissions by manipulating the voltage supplied to predetermined pathways. Those of ordinary skill are familiar with the electronic circuitry adapted to be in communication with the respective pathways 104, 118 to create a grid system resulting in a plurality of pixels operative to display images and even multi-color images when color phosphors are utilized as described previously.

It is also within the scope if the invention to provide leads (not shown) connected to the respective conductive pathways 104, 118 enabling communication with a direct current source having an exemplary voltage between 3-25 volts. An electric field is created by the direct flow through the conductive pathways 104, 118 that energizes the electroluminescent material 108, resulting in photoemissions. Control circuitry (not shown) in communication with the conductive pathways 104, 118 may be operative to change the intensity of the photoemissions by manipulating the voltage supplied to predetermined pathways. Those of ordinary skill are familiar with the electronic circuitry adapted to be in communication with the respective pathways 104, 118 to create a grid system resulting in a plurality of pixels operative to display images and even multi-color images when color phosphors are utilized as described previously.

It is also within the scope of the present invention to position a dielectric material (not shown) having a thickness of approximately 2 microns between the conductive paths 104 and the electroluminescent material 108 to fabricate a thin film electroluminescent display.

It is to be understood that three-dimensional shapes resulting from deposition of conductive material, dielectric material, and electroluminescent material in accordance with the present invention to fabricate an electroluminescent display may deviate from those shown within the exemplary drawings accompanying the present disclosure. The exemplary drawings and descriptions are not intended to provide an exhaustive basis for the scope of the invention as obvious variations apparent to those of ordinary skill shall likewise fall within the scope of the present invention.

While the above deposition steps have been described utilizing inks deposited by an inkjet printer, it is to be understood that one or more of the deposition steps may be carried out utilizing deposition techniques and devices outside of inkjet printer technology. For instance, the dielectric material may be deposited utilizing conventional semiconductor deposition techniques that include, without limitation, depositing a resist upon the conductive path(s) and thereafter developing the resist to provide for selective deposition of dielectric material through the resist. Subsequent to the dielectric deposition, the resist can be removed to retain the dielectric material in the predetermined pattern previously defined by the resist. Those of ordinary skill are familiar with the plethora of techniques for depositing materials to create a stacked structure. Alternatively, the dielectric material may be deposited utilizing laser printing technology, where the toner includes the dielectric material. In such an exemplary embodiment, the carrier fluid utilized with inkjet technology may be eliminated.

Alternatively, it is also within the scope of the present invention that the conductive material is deposited on the substrate and thereafter patterned and etched to arrive at the respective conductive paths. Those of ordinary skill in the semiconductor fabrication industry are readily familiar with techniques for patterning and etching of a substrate and material layers deposited thereon.

Following from the above description and invention summaries, it should be apparent to those of ordinary skill in the art that, while the methods and apparatuses herein described constitute exemplary embodiments of the present invention, the invention contained herein is not limited to these precise embodiments and changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since unforeseen advantages of the present invention may exist even though they have been explicitly discussed herein.

What is claimed is:

1. A method of fabricating an electroluminescent display comprising:
depositing a conductive pathway upon a substrate;
depositing a dielectric material over at least a first portion of the conductive pathway; and
depositing an electroluminescent material over the dielectric material and in contact with at least a second portion of the conductive pathway;
wherein at least one of the deposition acts is carried out utilizing an inkjet printer.

2. The method of claim 1, wherein:
the act of depositing the conductive pathway upon the substrate is carried out utilizing the inkjet printer; and
the inkjet printer utilizes a conductive ink including a first carrier fluid.

3. The method of any of claims 2, wherein at least one of the first carrier fluid, the second carrier fluid, and the third carrier fluid is water-based.

4. The method of claim 1, wherein:
the act of depositing the dielectric material in contact with at least the first portion of the conductive pathway is carried out utilizing the inkjet printer; and
the inkjet printer utilizes a dielectric ink including a second carrier fluid.

5. The method of any of claims 4, wherein at least one of the first carrier fluid, the second carrier fluid, and the third carrier fluid is water-based.

6. The method of claim 1, wherein:
the act of depositing the electroluminescent material in contact with the dielectric material and in contact with at least the second portion of the conductive pathway is carried out utilizing the inkjet printer; and
the inkjet printer utilizes an electroluminescent ink including a third carrier fluid.

7. The method of any of claims 6, wherein at least one of the first carrier fluid, the second carrier fluid, and the third carrier fluid is water-based.

8. The method of claim 1, wherein the act of depositing the dielectric material over at least the first portion of the conductive pathway occurs prior to the act of depositing the electroluminescent material over the dielectric material and in contact with at least the second portion of the conductive pathway.

9. The method of claim 1, wherein the deposition acts occur sequentially such that the act of depositing the electroluminescent material over the dielectric material and in contact with at least the second portion of the conductive pathway immediately follows the act of depositing the dielectric material over at least the first portion of the conductive pathway that immediately follows the act of depositing the conductive pathway upon the substrate.

10. A method of fabricating an electroluminescent display comprising:
depositing a dielectric material over at least a portion of a conductive material previously deposited; and
depositing an electroluminescent material over at least a portion of the dielectric material;
wherein the act of depositing the dielectric material and the act of depositing the electroluminescent material occur sequentially.

11. The method of claim 10, wherein:
the conductive material is deposited by vaporizing a portion of a conductive ink that includes the conductive material;
the act of vaporizing the portion of the conductive ink is operative to deposit the conductive material in a predetermined conductive material pattern; and
the predetermined conductive material pattern includes at least three conductive mesas, with at least one of the three conductive mesas being separable from an adjacent conductive mesa.

12. The method of claim 11, wherein:
the dielectric material is deposited by vaporizing a portion of a dielectric ink that includes the dielectric material;
the act of vaporizing the portion of the dielectric ink is operative to deposit the dielectric material in a predetermined dielectric material pattern; and
the predetermined dielectric material pattern includes conductively separating at least one of the three conductive mesas from the adjacent conductive mesa.

13. The method of claim 12, wherein:
the act of vaporizing the portion of the electroluminescent ink is operative to deposit the electroluminescent material in a predetermined electroluminescent material pattern; and
the predetermined electroluminescent material pattern includes interposing electroluminescent material between at least two adjacent conductive mesas.

14. The method of claim 11, further comprising:
removing a portion of the dielectric material deposited to generate a first predetermined dielectric material pattern; and
the first predetermined dielectric material pattern includes conductively separating at least one of the three conductive mesas from the adjacent conductive mesa.

15. The method of claim 14, wherein:
the electroluminescent material is deposited by vaporizing a portion of an electroluminescent ink that includes the electroluminescent material;
the act of vaporizing the portion of the electroluminescent ink is operative to deposit the electroluminescent material in a predetermined electroluminescent material pattern; and
the predetermined electroluminescent material pattern includes interposing electroluminescent material between at least two adjacent conductive mesas.

16. The method of claim 10, further comprising:
removing a portion of the conductive material deposited to generate a first predetermined pattern; and
the first predetermined pattern includes at least three conductive mesas, with at least one of the three conductive mesas being electrically separable from an adjacent conductive mesa.

17. The method of claim 16, wherein:
the dielectric material is deposited by vaporizing a portion of a dielectric ink that includes the dielectric material;
the act of vaporizing the portion of the dielectric ink is operative to deposit the dielectric material in a predetermined dielectric material pattern; and
the predetermined dielectric material pattern includes conductively separating at least one of the three conductive mesas from the adjacent conductive mesa.

18. The method of claim 17, wherein:
the electroluminescent material is deposited by vaporizing a portion of an electroluminescent ink that includes the electroluminescent material;
the act of vaporizing the portion of the electroluminescent ink is operative to deposit the electroluminescent material in a predetermined electroluminescent material pattern; and
the predetermined electroluminescent material pattern includes interposing electroluminescent material between at least two adjacent conductive mesas.

19. The method of claim 16, further comprising:
removing a portion of the dielectric material deposited to generate a first predetermined dielectric material pattern; and
the first predetermined dielectric material pattern includes conductively separating at least one of the three conductive mesas from the adjacent conductive mesa.

20. The method of claim 19, wherein:
the electroluminescent material is deposited by vaporizing a portion of an electroluminescent ink that includes the electroluminescent material;
the act of vaporizing the portion of the electroluminescent ink is operative to deposit the electroluminescent material in a predetermined electroluminescent material pattern; and
the predetermined electroluminescent material pattern includes interposing electroluminescent material between at least two adjacent conductive mesas.

21. The method of claim 10, further comprising depositing a second conductive material over at least a portion of the electroluminescent material previously deposited.

22. The method of claim 10, further comprising:
depositing a second dielectric material over at least a portion of the electroluminescent material previously deposited; and
depositing a second conductive material over at least a portion of the second dielectric material previously deposited.

23. An electroluminescent display comprising a stacked structure including at least three aspects, with a first aspect comprising a conductive pathway, a second aspect comprising a dielectric material overlying at least a portion of the conductive pathway, and a third aspect comprising an electroluminescent material overlying at least a portion of the dielectric material and in electrical communication with at least a portion of the conductive pathway, wherein at least one of the aspects is deposited utilizing an inkjet printer, and wherein electric current is adapted to be provided to the first component to generate at least one of an electric field and an electromagnetic field causing a photoemission from the electroluminescent material.

24. The electroluminescent display of claim 23, further comprising:
a fourth aspect comprising a second dielectric material overlying at least a portion of the electroluminescent material; and
a fifth aspect comprising a second conductive pathway overlying at least a portion of the second dielectric material.

25. The electroluminescent display of claim 24, wherein:
the conductive pathway includes a plurality of conductive mesas;
the dielectric material is deposited to separate at least a first conductive mesa and a third conductive mesa from a second conductive mesa;
the electroluminescent material is deposited in communication with at least a portion of the dielectric material and at least a portion of the second conductive mesa of the second conductive pathway includes a plurality of conductive mesas; and
the second dielectric material is operative to separate the second conductive pathway from the electroluminescent material.

26. The electroluminescent display of claim 23, further comprising a fourth aspect comprising a second conductive pathway overlying at least a portion of the electroluminescent material.

27. The electroluminescent display of claim 26, wherein:
the conductive pathway includes a plurality of conductive mesas;
the dielectric material is deposited to separate at least a first conductive mesa and a third conductive mesa from a second conductive mesa; and
the electroluminescent material is operative to separate the second conductive pathway from the electroluminescent material.

28. The electroluminescent display of claim 23, wherein:
the conductive pathway includes a plurality of conductive mesas;
the dielectric material is deposited to separate at least a first conductive mesa and a third conductive mesa from a second conductive mesa; and
the electroluminescent material is deposited in communication with at least a portion of the dielectric material and at least a portion of the second conductive mesa.
